(19) United States
(12) Patent Application Publication
(10) Pub. No.: US 2025/0387741 A1
(43) Pub. Date: Dec. 25, 2025

(54) METHOD AND APPARATUS FOR A FILTER COUPLING FRAME

(71) Applicant: American Air Filter Company, Inc., Louisville, KY (US)

(72) Inventors: Chris Todd, Bedlington Northumberland (GB); Paul Jackson, North Shields (GB)

(21) Appl. No.: 19/246,256

(22) Filed: Jun. 23, 2025

Related U.S. Application Data
(60) Provisional application No. 63/663,354, filed on Jun. 24, 2024.

(51) Int. Cl. B01D 46/00; B01D 46/56

(52) U.S. Cl. CPC B01D 46/0005; B01D 46/001; B01D 46/56

(57) ABSTRACT

A filter coupling frame connecting filters to each other. The filter coupling frame may include one or more couplings interchangeable with each other to releasably engage a variety of filters. The coupling may include one or more latches. The coupling may include one or more alignment structures.

### BACKGROUND

The present embodiments relate to a filter coupling frame, with particular embodiments shown for a filter coupling frame with interchangeable couplings.

Typical filter coupling frames that attach a prefilter to a final stage filter may allow only one type of prefilter with a fixed header dimension that may be limited to specific filtration arrangements. Thus, there is a need for a filter coupling frame used for a variety of upstream filters of different filter depths, shapes, and/or geometries to be coupled to the final filter to optimize the filtration system for different environmental or seasonal conditions.

### SUMMARY

In some embodiments of the invention, for example, a filter coupling frame may have a frame body defining a through opening from an upstream side to a downstream side. In various embodiments, the frame body may include one or more keepers. In some embodiments, the filter coupling frame may include a plurality of first couplings releasably coupled to the frame body and configured to releasably engage an upstream filter adjacent the upstream side of the frame body. In some embodiments, at least one first coupling of the plurality of first couplings may include a proximal end adjacent the frame body and a distal free end projecting upstream away from the frame body. In various embodiments, the distal free end may include a biased first latch configured to releasably engage an upstream filter. In some embodiments, the proximal end of the first coupling may include one or more biased second latches releasably engaging the one or more keepers of the frame body.

In addition, in some embodiments, the proximal end of at least one first coupling includes one or more alignment slots. In various embodiments, the one or more alignment slots may not be centered between two opposing biased second latches of the one or more biased second latches. In some embodiments, the one or more biased second latches may be perpendicular to the biased first latch. In various embodiments, the one or more keepers are at least one of an opening and/or a recess. In some embodiments, the proximal end of at least one first coupling may include a sleeve projecting inwardly from at least one first coupling. In various embodiments, the sleeve may include the one or more biased second latches. In some embodiments, at least one first coupling may include one or more ribs projecting outwardly therefrom and/or extend in a direction from the proximal end to the distal free end. In various embodiments, the frame body may include an outer periphery, wherein the outer periphery may include one or more receptacles receiving the proximal end of at least one first coupling. In some embodiments, the one or more receptacles may include one or more tabs projecting inwardly therefrom. In various embodiments, the frame body may include one or more engagement mechanisms adjacent the downstream side configured to engage a downstream filter.

In some embodiments, a filter assembly may include a filter coupling frame configured to space an upstream filter from a downstream filter. In various embodiments, the filter coupling frame may include a frame body defining a through opening from an upstream side to a downstream side. In some embodiments, the filter assembly may include a plurality of first couplings releasably coupled to the frame body and configured to releasably engage a first upstream filter having a first thickness adjacent the upstream side of the frame body. In various embodiments, the plurality of first couplings may be configured to be removed and replaced by a plurality of second couplings releasably coupled to the frame body and/or configured to releasably engage an upstream filter having a second thickness different from the first upstream filter adjacent the upstream side of the frame body.

In addition, in some embodiments, an outer periphery of the filter coupling frame may include one or more receptacles receiving the plurality of first couplings or the plurality of second couplings. In various embodiments, the one or more receptacles may include one or more tabs to guide the plurality of first couplings or the plurality of second couplings into or out of engagement therewith. In some embodiments, the one or more receptacles may include one or more keepers to releasably engage one or more latches of the plurality of first couplings or the plurality of second couplings. In various embodiments, the plurality of first couplings may include a first length between a distal free end and a proximal end and the plurality of second couplings include a second length different from the first length between a distal free end and a proximal end. In some embodiments, the plurality of first couplings and the plurality of second couplings may include a sleeve projecting from an interior side. In some embodiments, the sleeve may include one or more latches releasably engaging one or more keepers of the filter coupling frame and/or one or more alignment slots receiving one or more tabs of the filter coupling frame.

In some embodiments, a method of coupling upstream filters having different thicknesses to a downstream filter may include providing a filter coupling frame. In various embodiments, the method may include providing a plurality of first couplings having a first length. In some embodiments, the method may include providing a plurality of second couplings having a second length different than the first length. In various embodiments, determining a thickness of an upstream filter. In some embodiments, the method may include selecting one of the plurality of first couplings or the plurality of second couplings corresponding to the thickness of the upstream filter. In various embodiments, the method may include releasably engaging the plurality of first couplings or the plurality of second couplings to the filter coupling frame.

In addition, in some embodiments, the method may include removing the plurality of first couplings or the plurality of second couplings from the filter coupling frame. In various embodiments, the method may include guiding the plurality of first couplings or the plurality of second couplings into engagement with the filter coupling frame. In some embodiments, the method may include releasably engaging one or more latches of the plurality of first couplings or the plurality of second couplings to one or more keepers of the filter coupling frame. In some embodiments, the method may include releasably engaging at least one upstream filter to the plurality of first couplings or the plurality of second couplings. In various embodiments, the method may include releasably engaging at least one downstream filter to the filter coupling frame. In some embodiments, the method may include inserting the filter coupling frame and the plurality of first couplings or the plurality of second couplings to an opening defined by a filter holding frame. In various embodiments, the method may include centering the filter coupling frame and the plurality of first couplings or the plurality of second couplings within the opening defined by the filter holding frame via one or more ribs projecting from an exterior of the plurality of first couplings or the plurality of second couplings.

In some embodiments, a filter assembly kit may include at least a plurality of first couplings having a first length. In various embodiments, the kit may include at least a plurality of second couplings having a second length different than the first length. In some embodiments, the kit may include a filter coupling frame having one or more receptacles configured to releasably engage the plurality of first couplings or the plurality of second couplings.

In addition, in some embodiments, the kit may include at least a plurality of third couplings having a third length different from the first length and the second length. In various embodiments, the receptacle of the filter coupling frame may include a plurality of tabs and/or a plurality of keepers to releasably engage the plurality of first couplings and the plurality of second couplings. In some embodiments, the plurality of first couplings and the plurality of second couplings may each have a sleeve on a proximal end and a first latch on a distal free. In various embodiments, the sleeve may include a plurality of second latches configured to releasably engage an upstream filter and/or a plurality of alignment slots to releasably engage the one or more receptacles of the filter coupling frame. In various embodiments, the kit may include one or more filters.

These and other advantages and features, which characterize the embodiments, are set forth in the claims annexed hereto and form a further part hereof. However, for a better understanding of the embodiments, and of the advantages and objectives attained through its use, reference should be made to the drawings and to the accompanying descriptive matter, in which there are described example embodiments. This summary is merely provided to introduce a selection of concepts that are further described below in the detailed description, and is not intended to identify key or essential features of the claimed subject matter, nor is it intended to be used to limit the scope of the claimed subject matter, nor to define the field of endeavor.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of one embodiment of a filter holding frame with portions of the filter assembly/holding frame broken away, illustrating an embodiment of a filter coupling frame spacing three different prefilters away from the final filter(s), illustrating two different prefilters exploded away from the holding frame opening/cell and corresponding first/third coupling(s);

FIG. 2 is a perspective view of the one embodiment of a filter coupling frame of FIG. 1 with a plurality of couplings (e.g. third) releasably engaged thereto;

FIG. 3 is an exploded view of the filter coupling frame of FIG. 2;

FIG. 4A is a sectional view taken along line 4A-4A of FIG. 1 through a coupling (e.g. third), illustrating the biased latch (e.g. first) in broken lines out of engagement with the upstream filter, and illustrating the biased latch (e.g. second) in broken lines out of engagement with the frame body;

FIG. 4B is a sectional view taken along line 4B-4B of FIG. 1 through a coupling (e.g. first), illustrating the biased latch (e.g. first) in broken lines out of engagement with the upstream filter, and illustrating the biased latch (e.g. second) in broken lines out of engagement with the frame body;

FIG. 5 is a sectional view taken along line 5-5 of FIG. 3;

FIG. 6A is a perspective view of the interior side of the first coupling of FIG. 1;

FIG. 6B is a perspective view of the interior side of the second coupling of FIG. 1; and

FIG. 6C is a perspective view of the interior side of the third coupling of FIG. 1.

### DETAILED DESCRIPTION

Numerous variations and modifications will be apparent to one of ordinary skill in the art, as will become apparent from the description below. Therefore, the invention is not limited to the specific implementations discussed herein.

The embodiments discussed hereinafter will focus on the implementation of the hereinafter-described techniques for a filter coupling frame/adaptor 20, such as the type that may be used in an industrial, commercial, and/or residential environments such as, but is not limited to, gas turbine, industrial compressor air intake systems, structures for housing, buildings, clean rooms, or in other similar applications. However, it will be appreciated that the herein-described apparatus and techniques may also be used in connection with other types of filter holding systems in some embodiments. For example, the herein-described apparatus and techniques may be used in agricultural and/or seasonal changing environments in some embodiments. Moreover, the herein-described apparatus and techniques may be used in connection with a variety of filter/stage configurations and/or characteristics (e.g. upstream, downstream). The filter coupling frame 20 includes interchangeable couplings 50 to vary the upstream filters that the filter coupling frame 20 or filter assembly 10 may releasably engage for one or more applications.

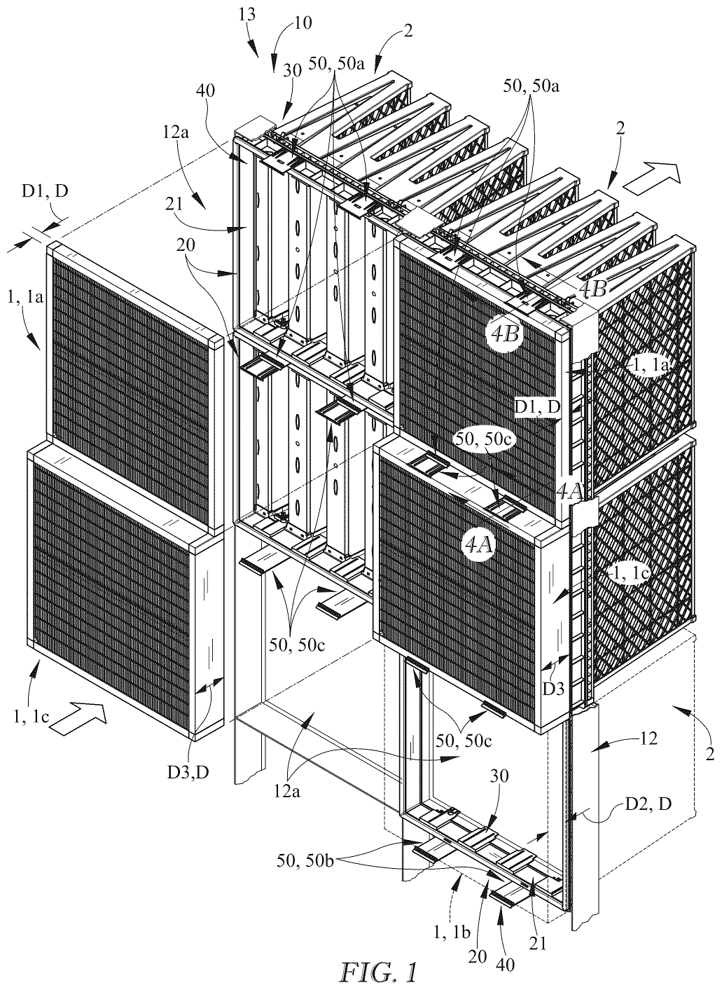

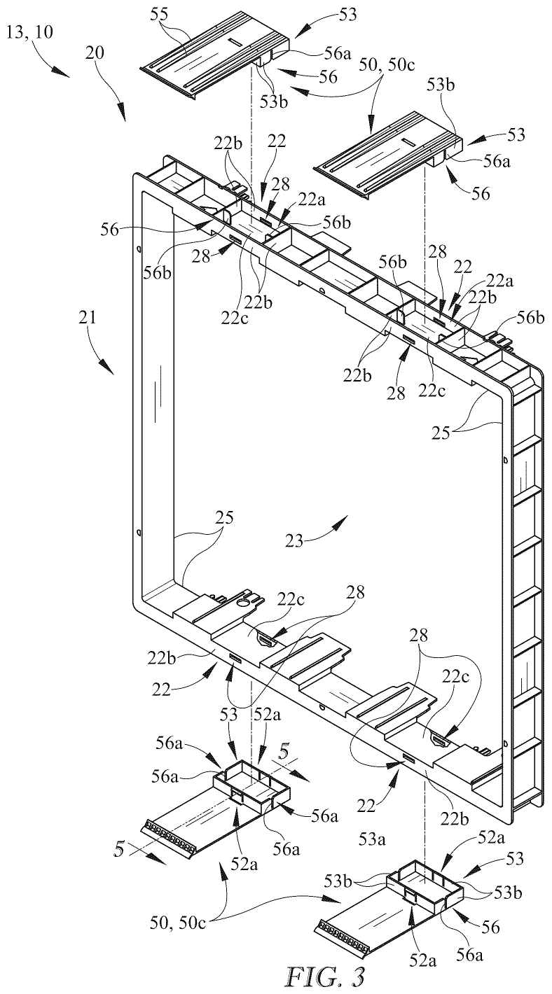

Turning now to the drawings, wherein like numbers denote like parts throughout the several views, FIGS. 1-6C illustrates an example filter coupling frame 20, or portions thereof, in which the various technologies and techniques described herein may be implemented. The filter coupling frame 20, or portions thereof, space or offset one or more upstream/first/stage filters 1 (e.g. prefilter) from the one or more downstream/second/stage filters 2 (e.g. final). The offset or space 20a is configured between the outlet plane of the upstream/first filter(s) 1 and the inlet plane of the downstream/second filter(s) 2. This space or gap 20a may allow a more uniform airflow across the inlet plane, or portions thereof, of the downstream filter(s) 2. This may utilize the entire or better filtering capacity of the final filter.

With the arrangements described, each prefilter 1 may be quickly and easily removed from the filter coupling frame 20 and/or coupling(s) 50 (e.g. first, second, third, etc.) and replaced with a new replacement prefilter, different prefilter, or upgraded to higher second stage filter. Furthermore, the filter coupling frame 20 may be retained in situ in the filter assembly 10 (e.g. filter holding frame 12) and can be re-used for several changes of the prefilter (e.g. stage, cartridges, canisters, box filter) and/or changes between couplings 50 (e.g. first, second, third, etc.). It should also be noted that the prefilter(s) 1 and/or couplings 50 may be changed when the final filter device does not ordinarily need changing but the pressure drop within the filter assembly is still greater than expected and/or another filtering characteristic is desired.

With the arrangements described, each coupling 50 may be quickly and easily removed from the filter coupling frame 20 and/or frame body 21 (e.g. first, second, third, etc.) and quickly attached/replaced with a new replacement coupling or different coupling corresponding to the desired prefilter 1 to be releasably engaged.

In some applications, the filter coupling frame 20, filter assembly 10, and/or kit 13 may include one or more couplings 50. Each coupling or plurality of couplings 50 (e.g. first, second, third, etc.) is configured to releasably engage and position one or more filters 1 (e.g. first 1a, second 2a, third, etc.) upstream of the filter coupling frame 20, filter holding frame/rack/support 12 (e.g. opening(s) 12a), and/or final filter(s) 2. The filter coupling frame 20 or frame body 21 releasably engages the one or more couplings 50. Alternatively stated, the one or more couplings 50 each releasably engage the frame body 21, or portions thereof. This may allow the user to select/replace a coupling 50 or plurality of couplings 50 (e.g. first 50a, second 50b, third 50c, etc.) to engage a desired prefilter or stage filter 1 (e.g. first 1a, second 1b, third 1c, etc.) while using the same/single frame body 21. For example, if a prefilter 1a (e.g. with a first depth) is desired for one application, the one or more couplings 50 (e.g. first 50a) may be releasably engaged to the frame body 21 and/or filter coupling frame 20. For example, if another or different prefilter 1b is desired for an application, the user may replace one or more couplings 50 (e.g. first 50a) with another one or more different couplings 50 (e.g. second 50b, third 50c) to engage the different prefilter 1b, 1c, etc. (e.g. with a second depth, with a third depth, etc.).

In some implementations, the filter coupling frame 20, or portions thereof, may be adjustable/interchangeable to engage different prefilter or stage filters 1 (e.g. having different depths) upstream of the final filter 2. The releasable/interchangeable couplings 50 may be used to engage prefilters 1 of a variety of different depths (e.g. first D1, second D2, third D2, etc.) or dimensions in the direction of airflow (e.g. between upstream and downstream planes). For example, the length (e.g. first L1) of the first coupling(s) 50a, if used, may correspond to a prefilter 1a having a depth D1 of about 2 inches. For example, the length (e.g. second L2) of the second coupling(s) 50b, if used, may correspond to a prefilter 1b having a depth D2 of about 4 inches. Further, for example, the length (e.g. third L3) of the third coupling(s) 50c, if used, may correspond to a prefilter 1c having a depth D3 of about 6 inches. It should be understood that other lengths of the coupling(s) 50 may be used and/or filters of additional filter depths/structure/shape/construction not described above may be releasably engaged by the coupling(s) 50, filter assembly 10, and/or filter coupling frame 20.

In some implementations, the filter coupling frame 20, frame body 21, and/or couplings 50, or portions thereof, may be made of a plastic material. The coupling(s) 50 (e.g. first, second, third, etc.) and/or frame body 21, or portions thereof, may be a plastic or polymer (e.g. ABS). The couplings 50 and/or frame body 21 may be injection molded and/or 3D printed in some embodiments. Although the coupling(s) and the frame body may be made of the same material, the materials may be different in some embodiments.

In some implementations, the filter coupling frame 20 and/or filter assembly 10, or portions thereof, may include a frame body 21. The frame body 21 and/or filter coupling frame 20 may couple the upstream filter(s) 1 to the downstream filter(s) 2. The frame body 21 and/or filter coupling frame 20 may include a first engagement mechanism 40 (e.g. latch mechanism, upstream, coupling 50) engaging/positioning the one or more upstream filters 1 (e.g. prefilters) and/or a second engagement mechanism 30 (e.g. latch mechanism, downstream) engaging/positioning the one or more downstream filters 2 (e.g. final). In the one embodiment shown in the figures, the first engagement mechanism 40 may include the one or more releasable/interchangeable couplings 50. It should be understood that the first engagement structure may be reversed such that the coupling includes the opening(s) and the frame body includes the latches in some embodiments. In the one embodiment shown in FIGS. 1-4B, the second engagement mechanism 30, if used, may include structure one or more latches or fasteners to engage the final filter 2. The second engagement mechanism 30 may allow for alignment (e.g. alignment posts, tabs, and/or members 31) and/or latching (e.g. latching members and/or clips 32) between the frame body 21 to the final filter 2 (e.g. AAF EASYFIT retention features/method). The second engagement mechanism 30, or portions thereof, may be integral or fixed to the frame body (e.g. adjacent the downstream side). Although one embodiment of the second engagement mechanism is shown, it should be understood that a variety of latching or second engagement mechanism(s) may be used to engage the final filter 2. In some embodiments, the second engagement mechanism may include a key feature such that only a particular final filter construction may be used. For example, if the final filter is not correct or correspondingly keyed it will not be able to attach to the keyed frame body, if used. It should be understood that the second engagement structure between the filter coupling frame and the final filter may be reversed in some embodiments.

In some implementations, filter coupling frame 20 and/or filter assembly 10 may include a frame body 21. The frame body 21 may include or define a through opening 23. The frame body 21 may include a plurality of members or walls 25 defining the through opening 23. The through opening 23 may extend from an upstream side 21a to a downstream side 21b of the frame body 21. The frame body 21 and/or walls 25 may include an outer periphery 26 and an inner periphery 27. The inner periphery 27 may define the through opening 23, or portions thereof. The frame body 21 may be substantially rectangular in shape (e.g. square). The first engagement mechanism 40 and/or frame body 21 may include one or more catches/keepers 28 and/or receptacle(s) 22 to releasably engage the corresponding one or more couplings 50 (e.g. second latches 52a, proximal end 51a). The outer periphery 26 of the frame body 21 may include one or more receptacles or receivers 22. The receptacles 22, if used, may include an opening 22a facing outwardly or perpendicular to the airflow/through opening 23. The receptacle 22 may include one or more walls 22b substantially rectangular in shape (e.g. square). The wall(s) 22b may extend from the outer periphery and connect to a bottom wall 22c. The one or more keepers 28 may be one or more recesses (e.g. not shown, with a bottom wall) or openings (e.g. through opening) as shown in the one embodiment. The receptacles 22 or walls 22b may include the one or more openings. Opposing openings/keepers 28 may be adjacent the upstream side and the downstream side of the receptacle 22, frame body 21, and/or outer periphery 26. The axis of the openings/keepers 28 may be in the direction of airflow and/or perpendicular to the opening 22a of the receptacle.

In some implementations, the filter assembly 10, frame body 21, and/or filter coupling frame 20 may include one or more couplings 50 (e.g. releasable, interchangeable, first 50a, second 50b, third 50c) to releasably engage one or more prefilters/filters 1 (e.g. first, second, third, upstream). The coupling(s) 50 may be releasably coupled to the frame body 21, or portions thereof (e.g. receptacles 22, outer periphery 26). The coupling 50 releasably engages an upstream filter 1 adjacent the upstream side 21a of the frame body 21. The coupling(s) 50 may include a proximal end 51a and an opposing distal free end 51b. The proximal end 51a may be adjacent to or releasably engage the frame body 21, of portions thereof (e.g. receptacle 22, outer periphery 26). The couplings 50 may be positioned on one or more sides/walls 25 of the frame body 21. The couplings (e.g. proximal end 51a) may releasably engage the top wall/member and/or the bottom wall member as shown in the one embodiment. The distal free end 51b may project away from (e.g. upstream) from the frame body 21 (e.g. upstream side 21a, outer periphery 26, receptacle 22). The distal free end 51b may project along the axis of the through opening 23. The distal free end 51b may include a biased latch(es) 52b (e.g. first) releasably engaging an upstream filter 1, or portions thereof. The first latch 52b may be biased towards the upstream filter 1 or flexed into or out of engagement with the upstream filter 1. The length of the coupling 50, first latch 52b, and/or distal free end 51b from the proximal end (e.g. sleeve) may correspond to the respective lengths (e.g. L1, L2, L3, etc.) of first coupling, second coupling, third coupling etc. to engage a variety of upstream filter(s)/stages (e.g. having corresponding depths, D1, D2, D3). The first latch 52b may extend from the sleeve 53, if used. The first latch 52b may include a barb/projection 52ba extending from the interior side 54a. The first latch 52b or interior side 54a of the distal free end 51b may include a cam surface 52bb adjacent or more distal than the barb 52ba. The first latch 52b or exterior side 54b of the distal free end 51b may include a push button/flange 52bc. The proximal end 51a of the coupling 50 may include one or more biased latches 52a (e.g. second) releasably engaging the frame body 21, or portions thereof (e.g. keepers/catches 28, recesses/openings, outer periphery 26, receptacle 22, wall 22b). The second latch 52a may be biased towards the keeper 28 or flexed into or out of engagement with the keeper or recess. As shown in the one embodiment, opposing biased second latches 52a engage the opposing openings/keepers 28 of the receptacle 22 and/or frame body 21. The proximal end 51a and/or coupling 50 may include one or more sleeves/posts/members 53 releasably engaging the frame body 21, or portions thereof (e.g. outer periphery 26, receptacle 22, wall 22b). The sleeve 53 may include one or more walls 53b. The sleeve 53 may include a plurality of walls 53b substantially rectangular in shape (e.g. square). The wall(s) 53b may extend or project from an interior side 54a of the coupling 50 towards the outer periphery 26 of the frame body 21 or receptacle 22. The sleeve 53 and/or wall(s) 53b may project inwardly from the coupling 50. The distal free end of the walls 53b spaced away from the interior side 54a may define an opening 53a. The distal free end of the sleeve walls 53b may be adjacent the barb 52aa/cam surface 52ab of the second latch 52a. The receptacle(s) 22 and/or outer periphery 26 of the frame body 21 may receive the proximal end 51a and/or sleeve 53, or portions thereof, of the coupling 50. As shown in the one embodiment, the proximal end 51a, sleeve 53, and/or wall(s) 53b slidably engage the inner periphery/opening 22a of the receptacle 22. The one or more sleeve walls 53b may include the one or more biased second latches 52a. The one or more second latches 52a may be in the plane of the one of the one or more sleeve walls 53b as shown in the one embodiment. The opposing biased second latches 52a may be positioned in opposing sleeve walls 53b adjacent the upstream side and downstream side of the frame body 21, receptacle 22, sleeve 53, and/or along the axis from the proximal end 51a towards the distal free end 51b. The one or more biased second latches 52a may be perpendicular to the biased first latch 52b as shown in the one embodiment.

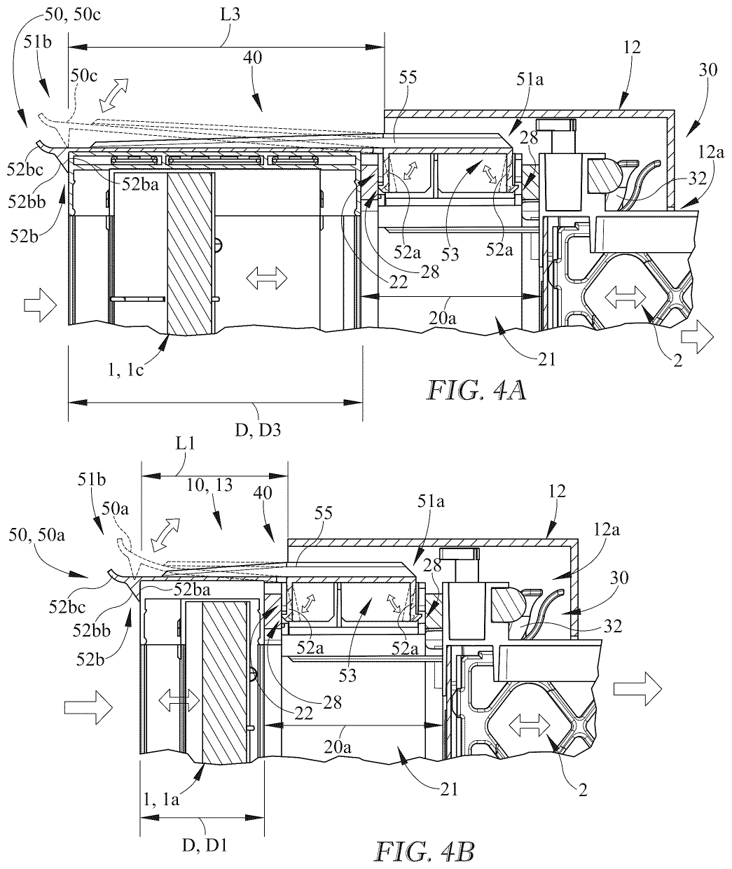

In some implementations, the filter coupling frame 20, filter assembly 10, and/or coupling 50 may include one or more ribs 55. The one or more ribs 55 may strengthen or support the first latch 52b and/or distal free end 51b of the coupling 50. As shown in FIGS. 1, 4A, and 4B, the one or more ribs 55 may center the filter coupling frame 20 and/or couplings 50 within the opening 12a of the filter holding frame 12. The one or more ribs 55 may bottom-out the filter coupling frame 20 and/or couplings 50 against the walls defining the opening 12a of the filter holding frame 12. As shown in FIGS. 4A and 4B, the ribs 55, if used, may bottom-out (e.g. outwardly away from the axis of the opening 12a) against the filter holding frame 12 walls (e.g. inner periphery) to reduce undesirable removal/dislodgment/movement (e.g. axial, longitudinal) of the assembly 10, or portions thereof, and/or prefilter 1 due to zero air force conditions. For example, the couplers may reduce excess flex and/or detachment of a loaded prefilter 1 once airflow is removed. The one or more ribs 55 may be on or project outwardly and/or away from the exterior side 54b of the coupling 50. The one or more ribs 55 may be elongated and/or extend for a portion of the length in a direction from the proximal end 51a to the distal free end 51b of the coupling.

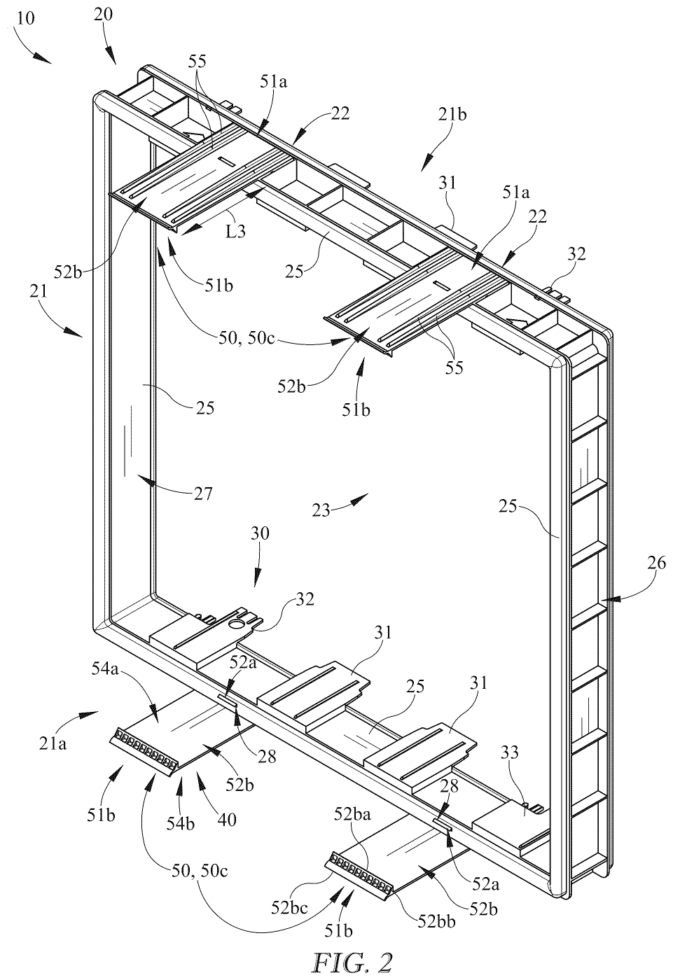

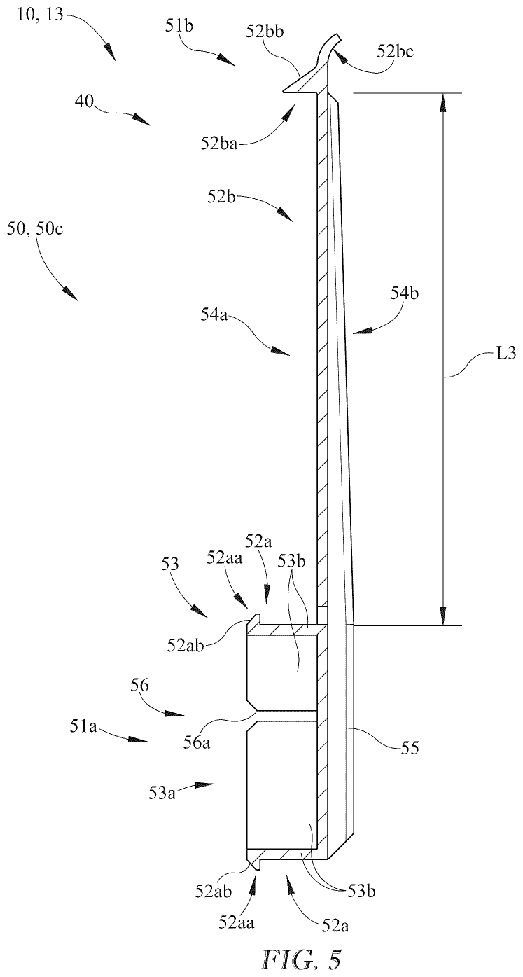

In some implementations, the assembly 10, filter coupling frame 20, frame body 21, and/or coupling 50 may include one or more interlock features 56. The interlock features 56, if used, may include one or more alignment slots/channels 56a engaging one or more tabs 56b. In the one embodiment shown in FIGS. 2-6C, the coupling 50, sleeve 53, and/or proximal end 51a may include the one or more alignment slots 56a. The one or more slots 56a, if used, extend from the distal free end of the sleeve 53 or wall 53b and extend towards the interior side of the coupling. The slots 56a may intersect with the opening 53a. Opposing walls 53b of the sleeve 53 (e.g. along the lateral edges between the proximal end 51a and distal free end 51b) may include the one or more alignment slots 56a. The second latches 52a and alignment slots 56a are on different walls in some embodiments. The slots 56a are in a plane intersecting the second latches 52a in another plane. The releasable engagement 40 and/or interlock feature 56, or portions thereof, between the coupling 50 and the frame body 21 may provide structure (e.g. position) for one way assembly therebetween. In the one embodiment shown, the one or more alignment slots 56a, if used, may be more adjacent to a biased latch 52a or one wall 53b of the sleeve 53 to guide or provide one way assembly of the coupling to the frame body. Stated alternatively and more clearly shown in FIGS. 4A, 4B, and 5, the alignment slot 56a may not be centered between the two opposing biased second latches 52a. In the one embodiment shown, the frame body 21, receptacle 22, and/or outer periphery 26 may include one or more tabs 56b. The receptacles 22 and/or wall(s) 22b may include the one or more tabs 56b projecting inwardly therefrom into the opening 22a of the receptacle 22. The tabs 56b may be substantially planar members and/or positioned in a single plane as shown. The tabs 56b may be spaced closer to the upstream side of the frame body 21 and/or receptacle 22. Two opposing tabs 56b may be used. Opposing walls 22b of the receptacle 22 (e.g. along the lateral edges between the receptacle connecting the upstream side to the downstream side) may include one or more tabs 56b. The openings 28 and tabs 56b may be on different walls in some embodiments. The two opposing tabs 56b may project from opposing receptacle walls 22b connecting the wall(s) having the one or more openings/keepers 28. The tabs 56b may be in a plane intersecting the recesses in another plane.

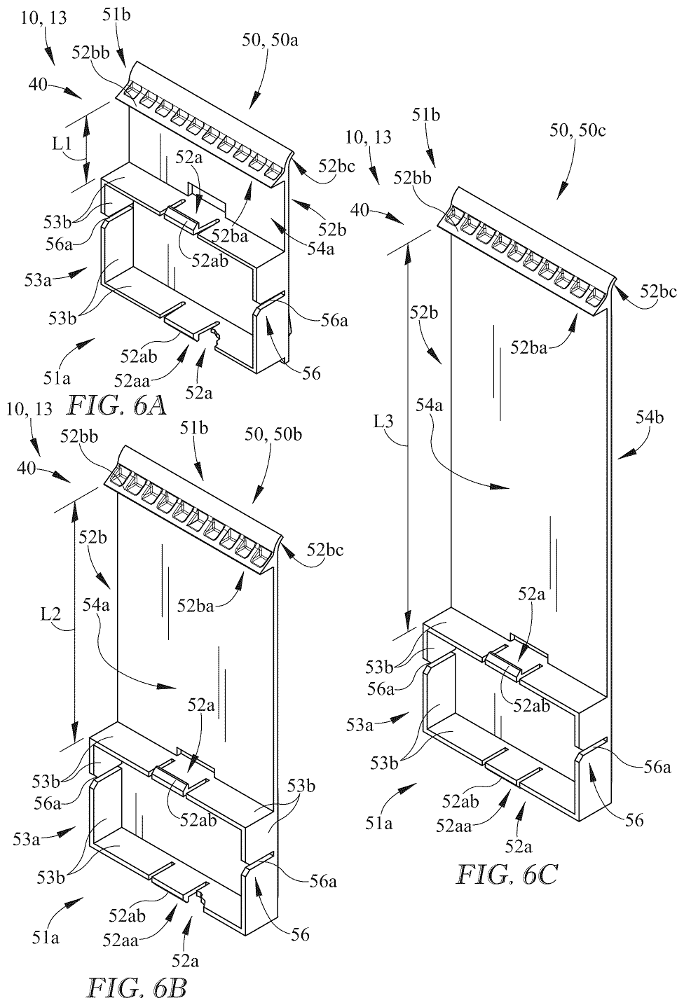

In some implementations, the filter assembly may include a filter coupling frame 20 having one or more first couplings 50a (e.g. having a first length L1) interchangeable with one or more second/another couplings 50b, 50c (e.g. having a second/another length L2 or third length L3 different from the first length). It should be understood that a third or additional coupling(s) 50c may be used in some embodiments. The filter assembly 10 may include a filter coupling frame 20 and/or one or more filters 1, 2 (e.g. upstream, downstream) in some embodiments. When the first coupling(s) 50a is releasably coupled to the frame body 21, the first coupling(s) 50a may be configured to releasably engaged one or more first upstream filters 1a having a first thickness/depth D1 (e.g. adjacent the upstream side of the frame body). When the second coupling(s) 50b is releasably coupled to the frame body 21, the second coupling(s) 50b may be configured to releasably engaged one or more second upstream filters 1b having a second thickness/depth D2 (e.g. adjacent the upstream side of the frame body). The second thickness D2 may be different from the first thickness D1 of the first upstream filter adjacent the upstream side of the frame body. When the third coupling(s) 50c is releasably coupled to the frame body 21, the third coupling(s) 50c may be configured to releasably engaged one or more third upstream filters 1c having a third thickness/depth D3 (e.g. adjacent the upstream side of the frame body). The third thickness D3 may be different from the first thickness D1 and/or second thickness D2 of the upstream filter adjacent the upstream side of the frame body. The corresponding coupling 50 (e.g. first, second, third, etc.) used or provided may engage a particular upstream filter 1 having a predetermined thickness/characteristic. If couplings 50 (e.g. first) are attached to the frame body 21, the couplings 50 currently being used may be removed and replaced (e.g. interchanged) by another coupling 50 (e.g. second, third, etc.) different from the previously removed coupling (e.g. first). If no couplings are attached to the frame body, the user or manufacturer may releasably couple the desired coupling 50 (e.g. having a desired length) to the frame body corresponding to the desired prefilter 1 for an application. It should be understood, that the filter coupling frame 20 or frame body 21 may include one or more receptacles 22 that may receive the first couplings 50a, second couplings 50b, or the third couplings 50c, etc. (e.g. sleeve, proximal end, tab, latch). The receptacles and/or frame body may guide the coupling into or out of engagement. If the receptacles 22 are used, the one or more receptacles 22 may include one or more tabs 56b to guide the respective coupling 50 (e.g. first or second, etc.) into or out of engagement with the receptacle 22, frame body 21, and/or alignment slots 56a. Further, the receptacles 22 may include one or more keepers 28 (e.g. opening) to releasably engage one or more latches 52a (e.g. second) of the respective coupling (e.g. first or second, etc.). As shown in FIGS. 1, 4B, and 6A, the first coupling 50a, if used, may include a first length L1. As shown in FIGS. 1 and 6B, the second coupling 50b, if used, may include a second length L2. As shown in FIGS. 1-4A and 6C, the third coupling 50c, if used, may include a third length L3. The lengths (e.g. L, L1, L2, L3, etc.) of the respective coupling 50 may be different from the one or more other couplings 50 available to interchange therewith for a particular application. It should be understood that the different lengths may be measured in a direction from the distal free end and the proximal end of the respective coupling. More specifically, the length may be measured from the distal free end or barb of the first latch to the sleeve/frame body/receptacle. Each coupling (e.g. first, second, third, etc.) may include a sleeve 53 or second latch 52a and/or projection(s)/barb 52aa received by the receptacle 22 or portion of the frame body when stowed or assembled. Each coupling 50 and/or sleeve 53 may include one or more second latches 52a engaging one or more keepers/catches 28 of the frame body 21 and/or one or more slots 56a, if used, receiving one or more tabs 56b, if used, of the filter coupling frame 20 or frame body 21. It should be understood that the slots and tabs may be reversed within the structure such that the sleeve includes the tab(s) and the receptacle includes the slots in some embodiments.

In some implementations, a filter assembly kit 13 may include at least one or more couplings 50/50a/50b/50c of a variety of lengths (e.g. L1, L2, L3, etc.). The filter assembly kit 13 may include one or more first couplings 50a (e.g. having a first length L1), one or more second couplings 50b (e.g. having a second/different length L2), and/or one or more third couplings 50c (e.g. having a third/different length L3), etc. In various embodiments, the filter assembly kit 13 may include at least one coupling 50 of a length. In some embodiments, the filter assembly kit may include at least one filter coupling frame 20 or frame body 21. In some embodiments, the kit may include one or more filters and/or filter holding frame. The filter coupling frame (e.g. one or more receptacles) may be configured to releasably engage the one or more first couplings 50a, second couplings 50b, or third couplings 50c, etc. depending on the application. Each coupling 50 may include latches or fasteners 52a (e.g. second) and/or slots 56a, if used, to releasably engage the frame body 21. Each coupling 50 may include one or more latches 52b (e.g. first, biased) to releasably engage the one or more upstream filters 1. The filter coupling frame 20 and/or frame body 21 may include one or more tabs 56b, if used, and/or one or more keepers 28. In some embodiments, the kit may include one or more filters (e.g. upstream, downstream, box type, V-Bank, upstream V-Bank, downstream V-bank, etc.).

In use, in some implementations, if one or more couplings 50 are not already releasably attached to the filter coupling frame 20 and/or frame body 21, one or more couplings 50 or first couplings 50a (e.g. length, first length) may be releasably attached thereto and configured to releasably engage a desired upstream prefilter 1a having a corresponding desired first thickness/depth D1. If one or more couplings 50 are already attached to the filter coupling frame/body and another or different upstream prefilter having a corresponding desired/different thickness D is needed for an application, the attached coupling(s) may be removed and replaced by another/different coupling(s) (e.g. length, different length) releasably attached to the filter coupling frame/body and configured to releasably engage the desired/different upstream prefilter having a corresponding desired/different thickness/characteristics. When the desired coupling 50 is attached having the desired/corresponding length to accommodate the desired prefilter having the corresponding thickness/depth, one or more prefilters or upstream filters may be releasably engaged to the corresponding couplings 50. As shown in FIGS. 4A and 4B, the couplings 50 and/or first latch 52b may be pushed/pulled outwardly by the user via a push button or flange 52bc and/or insertion of the prefilter 1 in the direction towards the filter coupling frame may cam the first latch 52b outwardly via a cam surface 52bb. Once the prefilter 1 is in position, the first latch 52b (e.g. barb/projection 52ba, biased towards prefilter) of the coupling 50 may bias or return towards engagement with one or more structures of the prefilter or engage the upstream face of the prefilter. The user may push/pull against the bias of the first latch out of engagement with the prefilter via the push button 52bc if desired to change or replace the prefilter.

In use, the coupling 50 having a predetermined length L1, L2, L3 is releasably engaged when in use and/or may be releasably disengaged when not in use. The frame body 21 may be used without a coupling 50 (e.g. first, second, etc.) in some applications. To releasably engage the coupling 50 (e.g. first, second, third, etc.), the coupling 50 is positioned into alignment. In some applications there may be only a one-way assembly, defined by one or more interlock features 56. For example, if the first latch is extending downstream the coupling will not releasably engage the frame body 21. Alignment or one way assembly, if used, may be when the coupling is in an orientation with the distal free end 51b or first latch 52b projects upstream from the frame body 21. For example, the interlock feature 56 and/or the alignment slot(s) 56a and tab(s) 56b are in alignment. In some embodiments, one way assembly or structure(s) may not be used. With the receptacle 22 and sleeve 53 aligned (e.g. axially) and orientated correctly, the coupling 50 may telescope and/or slide together within the frame body 21. More specifically, the sleeve 53 telescopes within the opening 22a of the receptacle 22. Further, the tabs 56b telescope within the alignment slots 56a. Before reaching the one or more openings/keepers 28 to engage the opening as shown in FIGS. 4A and 4B, the one or more second latches 52a may be pushed/pulled inwardly (e.g. via cam surfaces 52ab, against the bias of the second latch) into the receptacle or away from the wall(s) 22b. Upon sufficient insertion or depth, the inwardly positioned one or more second latches 52a may return/spring/move/bias outwardly towards the receptacle or wall(s) 22b to engage the one or more openings/keepers 28. With the coupling 50 of the desired length L1, L2, or L3 engaged to the frame body 21, one or more prefilters or upstream filter 1 may be releasably secured to the first latch(es) 52b or coupling(s) 50. When inserting the prefilter 1, the one or more first latches 52b may cam outwardly (e.g. via cam surfaces 52bb) until reaching/engaging the upstream plane or face of the prefilter 1. Upon sufficient insertion or depth (e.g. longitudinal) of the prefilter towards the filter coupling frame 20, the outwardly positioned one or more first latches 52b may return/move/spring/bias inwardly to engage the upstream plane/face/structure of the prefilter 1. If desired to change the installed prefilter 1 with another or different depth/thickness, the installed prefilter may be removed by biasing the first latch 52b or coupling 50 (e.g. distal free end 51b) outwardly (e.g. via the push button 52bc) and longitudinally separating the prefilter from the filter frame coupling and/or coupling. If desired to change or interchange to another/different coupling of a different length, the second latch(es) 52a may be pushed/moved/forced inwardly or out of engagement with the one or more openings 28 to separate from the one or more keepers. Then the installed coupling 50 is telescoped and/or slid away from the frame body 21/receptacle 22. The one or more tabs 56b is slid out of the alignment slots 56a, if used, when separated/telescoped therefrom. Upon removal, a different coupling (e.g. second, third, etc.) of a different/second/third length may be releasably engaged to the frame body or receptacle as described above. Subsequently, the prefilter with the different thickness may be releasably engaged with the different coupling(s) (e.g. second, third).

In some implementations, the coupling of one or more upstream filters 1 (e.g. prefilters, stages) having different thickness/depths and/or other characteristics to a downstream or final filter 2 may include providing one or more couplings 50 of different lengths/dimensions/structure/shapes. For example, providing a plurality of first couplings 50a with a first length L1 as shown in FIG. 6A. For example, providing a plurality of second couplings 50b with a second length L2 as shown in FIG. 6B, different from at least the first length L1. For example, providing a plurality of third couplings 50c with a third length L3 as shown in FIG. 6C, different from at least the first and second lengths L1, L2. The method may include providing a filter coupling frame 20 or frame body 21. The method may include selecting and/or determining a thickness/depth of one or more upstream filters and/or upstream filter(s) 1. The method may include selecting one (e.g. set, length) of the plurality of couplings 50, first, second, third, etc. corresponding to the thickness/depth D of the upstream filter 1 (e.g. desired, predetermined, selected). The method may include releasably engaging one (e.g. set, length) of the plurality of couplings 50, first, second, third, etc. to the filter coupling frame/body 20, 21. The method may include releasably engaging one or more final filters to the filter coupling frame. The method may include installing the filter assembly 10, or portions thereof, (e.g. filter coupling frame, one or more couplings, prefilter, final filter) into a filter holding frame 12 or opening 12a. The method may include removing the one (e.g. set, length) of the plurality of couplings 50, first second, third, etc. from the filter coupling frame/body 20, 21. The method may include aligning the couplings 50 (e.g. plurality of first couplings, the plurality of second couplings) into engagement with the filter coupling frame/body 20, 21. The method may include telescoping/sliding the couplings 50 (e.g. plurality of first couplings, the plurality of second couplings) into engagement with the filter coupling frame/body. The method may include releasably engaging one or more latches 52a (e.g. second) of the couplings 50 (e.g. plurality of first couplings, the plurality of second couplings, etc.) to one or more keepers 28 of the filter coupling frame/body. The method may include releasably engaging at least one upstream filter 1 to the couplings 50 (e.g. plurality of first couplings, the plurality of second couplings, etc.). The method may include releasably engaging at least one downstream filter 2 to the filter coupling frame and/or engagement mechanism (e.g. second 30). The method may include inserting the filter coupling frame 20, frame body 21, and/or the couplings 50 (e.g. the plurality of first couplings, the plurality of second couplings, etc.) into one or more openings 12a defined by a filter holding frame 12. The method may include removing the filter coupling frame 20, frame body 21, and/or the coupling(s) 50 (e.g. the plurality of first couplings, the plurality of second couplings, etc.) from one or more openings 12a defined by a filter holding frame 12. The method may include centering the filter coupling frame 20, frame body 21, and/or the coupling(s) 50 (e.g. plurality of first couplings, the plurality of second couplings, etc.) within the opening 12a defined by the filter holding frame 12 via one or more ribs 55 (e.g. projecting from an exterior side 54b of the one or more couplings).

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A filter coupling frame comprising:
a frame body defining a through opening from an upstream side to a downstream side, and wherein the frame body includes one or more keepers; and
a plurality of first couplings releasably coupled to the frame body and configured to releasably engage an upstream filter adjacent the upstream side of the frame body, at least one first coupling of the plurality of first couplings includes a proximal end adjacent the frame body and a distal free end projecting upstream away from the frame body, and the distal free end includes a biased first latch configured to releasably engage an upstream filter and the proximal end of the first coupling includes one or more biased second latches releasably engaging the one or more keepers of the frame body.

2. The filter coupling frame of claim 1 wherein the proximal end of the at least one first coupling includes one or more alignment slots.

3. The filter coupling frame of claim 2 wherein the one or more alignment slots are not centered between two opposing biased second latches of the one or more biased second latches.

4. The filter coupling frame of claim 1 wherein the one or more biased second latches are perpendicular to the biased first latch.

5. The filter coupling frame of claim 1 wherein the one or more keepers are at least one of an opening and/or a recess.

6. The filter coupling frame of claim 1 wherein the proximal end of the at least one first coupling includes a sleeve projecting inwardly from the at least one first coupling.

7. The filter coupling frame of claim 6 wherein the sleeve includes the one or more biased second latches.

8. The filter coupling frame of claim 1 wherein the at least one first coupling further comprises one or more ribs projecting outwardly therefrom and extending in a direction from the proximal end to the distal free end.

9. The filter coupling frame of claim 1 wherein the frame body includes an outer periphery, wherein the outer periphery includes one or more receptacles receiving the proximal end of the at least one first coupling.

10. The filter coupling frame of claim 9 wherein the one or more receptacles include one or more tabs projecting inwardly therefrom.

11. The filter coupling frame of claim 1 wherein the frame body includes one or more engagement mechanisms adjacent the downstream side configured to engage a downstream filter.

12. A filter assembly comprising:
a filter coupling frame configured to space an upstream filter from a downstream filter, wherein the filter coupling frame includes a frame body defining a through opening from an upstream side to a downstream side; and
a plurality of first couplings releasably coupled to the frame body and configured to releasably engage a first upstream filter having a first thickness adjacent the upstream side of the frame body, wherein the plurality of first couplings are configured to be removed and replaced by a plurality of second couplings releasably coupled to the frame body and configured to releasably engage an upstream filter having a second thickness different from the first upstream filter adjacent the upstream side of the frame body.

13. The filter assembly of claim 12 wherein an outer periphery of the filter coupling frame includes one or more receptacles receiving the plurality of first couplings or the plurality of second couplings, and wherein the one or more receptacles include one or more tabs to guide the plurality of first couplings or the plurality of second couplings into or out of engagement therewith and wherein the one or more receptacles include one or more keepers to releasably engage one or more latches of the plurality of first couplings or the plurality of second couplings.

14. The filter assembly of claim 12 wherein the plurality of first couplings include a first length between a distal free end and a proximal end and the plurality of second couplings include a second length different from the first length between a distal free end and a proximal end.

15. The filter assembly of claim 14 wherein the plurality of first couplings and the plurality of second couplings include a sleeve projecting from an interior side, wherein the sleeve includes one or more latches releasably engaging one or more keepers of the filter coupling frame and one or more alignment slots receiving one or more tabs of the filter coupling frame.

16. A method of coupling upstream filters having different thicknesses to a downstream filter comprising the steps of:
providing a filter coupling frame;
providing a plurality of first couplings having a first length;
providing a plurality of second couplings having a second length different than the first length;
determining a thickness of an upstream filter;
selecting one of the plurality of first couplings or the plurality of second couplings corresponding to the thickness of the upstream filter; and
releasably engaging the plurality of first couplings or the plurality of second couplings to the filter coupling frame.

17. The method of claim 16 further comprising removing the plurality of first couplings or the plurality of second couplings from the filter coupling frame.

18. The method of claim 16 further comprising guiding the plurality of first couplings or the plurality of second couplings into engagement with the filter coupling frame.

19. The method of claim 16 further comprising releasably engaging one or more latches of the plurality of first couplings or the plurality of second couplings to one or more keepers of the filter coupling frame.

20. The method of claim 16 further comprising releasably engaging at least one upstream filter to the plurality of first couplings or the plurality of second couplings.

21. The method of claim 16 further comprising releasably engaging at least one downstream filter to the filter coupling frame.

22. The method of claim 16 further comprising inserting the filter coupling frame and the plurality of first couplings or the plurality of second couplings to an opening defined by a filter holding frame.

23. The method of claim 22 further comprising centering the filter coupling frame and the plurality of first couplings or the plurality of second couplings within the opening defined by the filter holding frame via one or more ribs projecting from an exterior of the plurality of first couplings or the plurality of second couplings.

24. A filter assembly kit comprising:
at least a plurality of first couplings having a first length;
at least a plurality of second couplings having a second length different than the first length; and
a filter coupling frame having one or more receptacles configured to releasably engage the plurality of first couplings or the plurality of second couplings.

25. The kit of claim 24 further comprising at least a plurality of third couplings having a third length different from the first length and the second length.

26. The kit of claim 24 wherein the receptacle of the filter coupling frame includes a plurality of tabs and/or a plurality of keepers to releasably engage the plurality of first couplings and the plurality of second couplings.

27. The kit of claim 24 wherein the plurality of first couplings and the plurality of second couplings each have a sleeve on a proximal end and a first latch on a distal free, wherein the sleeve includes a plurality of second latches configured to releasably engage an upstream filter and/or a plurality of alignment slots to releasably engage the one or more receptacles of the filter coupling frame.

28. The kit of claim 24 further comprising one or more filters.
